(19) United States
(12) Patent Application Publication
(10) Pub. No.: US 2026/0261755 A1
(43) Pub. Date: Sep. 3, 2026

(54) IMAGING APPARATUS, INFORMATION PROCESSING SYSTEM, AND METHOD

(71) Applicants: Makoto Torikoshi, KANAGAWA (JP); Makoto Odamaki, KANAGAWA (JP)

(72) Inventors: Makoto Torikoshi, KANAGAWA (JP); Makoto Odamaki, KANAGAWA (JP)

(73) Assignee: Ricoh Company, Ltd., Tokyo (JP)

(21) Appl. No.: 19/545,677

(22) Filed: Feb. 20, 2026

(30) Foreign Application Priority Data
Mar. 3, 2025 (JP) 2025-032564
Dec. 18, 2025 (JP) 2025-265412

(51) Int. Cl. H04N 23/617; G06F 16/583; H04N 23/62; H04N 23/63; H04N 23/661; H04N 23/90

(52) U.S. Cl. CPC H04N 23/617; G06F 16/583; H04N 23/62; H04N 23/631; H04N 23/661; H04N 23/90

(57) ABSTRACT

An imaging apparatus includes an imaging device to capture an image, and circuitry that sets metadata to be added based on a selected metadata setting method, and adds the set metadata to the captured image.

### CROSS-REFERENCE TO RELATED APPLICATIONS

This patent application is based on and claims priority pursuant to 35 U.S.C. §119(a) to Japanese Patent Application Nos. 2025-032564, filed on March 3, 2025, and 2025-265412, filed on December 18, 2025, in the Japan Patent Office, the entire disclosure of which is hereby incorporated by reference herein.

### BACKGROUND

### Technical Field

The present disclosure relates to an imaging apparatus, an information processing system, and a method.

### Related Art

With the development of information processing technology, a technique of adding metadata to data of an image has been developed to improve the searchability and manageability of the image.

For example, there is a technique of generating, as metadata, additional information to be used in advance to represent data information of binary data such as image data, moving image data, or audio data. The generated same metadata is repeatedly added to multiple items of binary data to be generated and used. Accordingly, the binary data with the metadata can be easily generated.

However, with the above-described technique, the metadata registered in advance is added to the binary data, and the method of adding the metadata cannot be selected, resulting in low selectivity of the user.

### SUMMARY

The present disclosure described herein provides an imaging apparatus including an imaging device that captures an image; and circuitry. The circuitry sets metadata to be added based on a selected metadata setting method; and adds the set metadata to the captured image.

The present disclosure described herein provides an information processing system including an imaging apparatus including an imaging device that captures an image; and an information processing apparatus including circuitry. The circuitry sets metadata to be added based on a selected metadata setting method; and adds the set metadata to the captured image.

The present disclosure described herein provides a method including selecting a metadata setting method; setting metadata to be added by the selected metadata setting method; capturing an image; and adding the set metadata to the captured image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an example of a configuration of an information processing system;

FIG. 2 is a cross-sectional view of an example of a spherical-image capturing apparatus;

FIG. 3 is a block diagram of an example of hardware of the spherical-image capturing apparatus;

FIG. 4 is a block diagram illustrating an example of software included in the spherical-image capturing apparatus;

FIG. 5 is a flowchart of an example of processes executed by the spherical-image capturing apparatus;

FIG. 6 is a view illustrating an example of a screen for selecting a metadata setting method displayed on the spherical-image capturing apparatus;

FIGS. 7A to 7C are views illustrating examples of a screen for setting metadata displayed on the spherical-image capturing apparatus;

FIG. 8 is a diagram illustrating an example in which the spherical-image capturing apparatus reads a code;

FIG. 9 is a view illustrating an example of a setting file of a list of metadata;

FIG. 10 is a schematic diagram illustrating an example of a configuration of an information processing system;

FIG. 11 is a diagram illustrating an example of a hardware configuration included in a server apparatus and a personal computer terminal;

FIG. 12 is a block diagram of an example of software included in the information processing system;

FIGS. 13A to 13C are diagrams illustrating an example of various tables to be managed;

FIG. 14 is a flowchart of an example of a process of setting metadata;

FIGS. 15A and 15B are views illustrating examples of a screen relating to setting of metadata displayed on the personal computer terminal; and

FIGS. 16A and 16B are views illustrating examples of a screen relating to setting of metadata displayed on the personal computer terminal.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

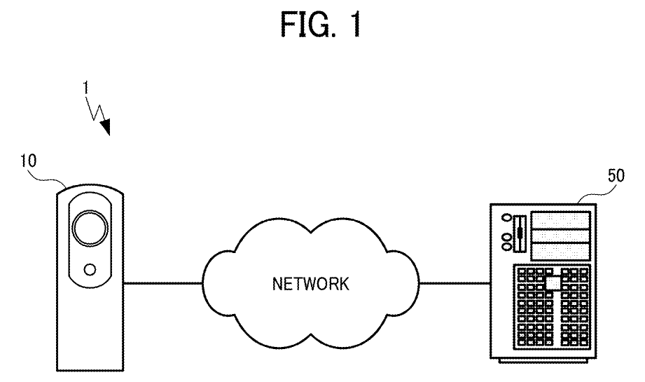

FIG. 1 is a schematic diagram illustrating a configuration of an information processing system 1 according to the present embodiment. FIG. 1 illustrates, as an example, an environment in which an imaging apparatus 10 and a server apparatus 50 are connected to each other via a network such as the Internet or a local-area network (LAN). The number of imaging apparatuses 10 is not limited to the number illustrated in FIG. 1, and the number of apparatuses included in the information processing system 1 is not limited. A method of connecting each apparatus to the network may be either wired or wireless.

The imaging apparatus 10 is an apparatus that captures and records an image. For example, the imaging apparatus 10 can capture an image such as a still image or a moving image. The imaging apparatus 10 can add predetermined metadata to the data of the captured image. Accordingly, the searchability and manageability of the captured image can be increased. An apparatus that captures an image having a solid angle of 4π steradians (referred to as a spherical-image capturing apparatus 10A) is illustrated as an example of the imaging apparatus 10 in the embodiment to be described below; however, no limitation is intended thereby.

The server apparatus 50 is an information processing apparatus that provides a service according to the present embodiment. For example, the server apparatus 50 can set the operation of the imaging apparatus 10, and store and manage an image captured by the imaging apparatus 10. The server apparatus 50 may be divided into multiple servers on the function basis. The server apparatus 50 may be divided into, for example, a server that sets the operation of the imaging apparatus 10 and a server that manages an image. For example, the user can access the server apparatus 50 from a terminal such as a personal computer or a smartphone and search for an image stored in the server apparatus 50.

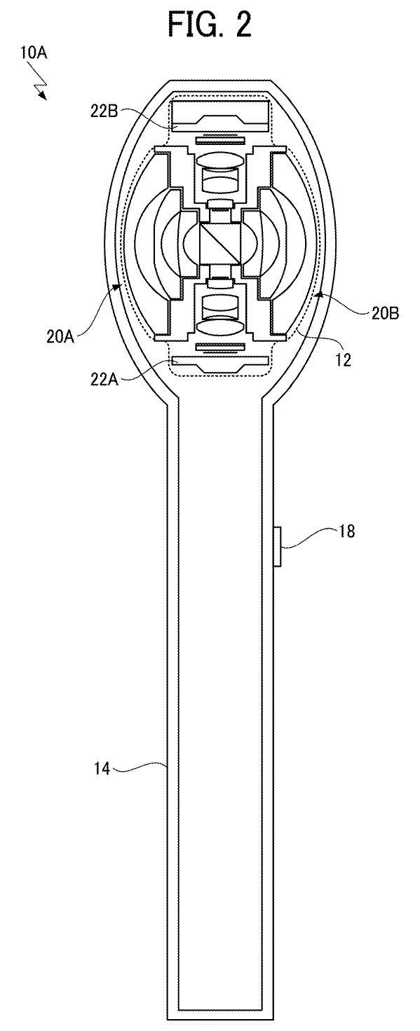

FIG. 2 is a cross-sectional view of the spherical-image capturing apparatus 10A according to the present embodiment. The spherical-image capturing apparatus 10A illustrated in FIG. 2 includes an imaging body 12, a casing 14 that holds the imaging body 12 and components such as a control board and a battery, and a shutter button 18 provided on the casing 14.

The imaging body 12 illustrated in FIG. 2 includes two lens optical systems 20A and 20B and two image sensors 22A and 22B. The image sensors 22A and 22B each are, for example, a complementary metal oxide semiconductor (CMOS) sensor or a charge coupled device (CCD) sensor. The image sensors 22A and 22B are disposed such that the respective imaging surfaces oppose each other. While the two image sensors 22A and 22B are provided as multiple imaging devices for the two lens optical systems 20A and 20B in the embodiment described here, this is merely one example. In another example, different portions of one image sensor may be used as imaging devices, and images may be formed on the portions of the one image sensor through the multiple lens optical systems 20A and 20B. Each of the lens optical systems 20A and 20B (hereinafter, referred to collectively as a lens optical system 20) is configured as a fish-eye lens including, for example, seven lenses in six groups or fourteen lenses in ten groups. In the embodiment illustrated in FIG. 2, the above-mentioned fish-eye lens has a full angle of view of more than 180 degrees (= 360 degrees/n, where n denotes the number of optical systems and n is 2), or preferably has an angle of view of 190 degrees or more. In the embodiment described here, two fish-eye lenses each having a full angle of view of 180 degrees or more are used. However, three or more lens optical systems and image sensors may be included as long as a predetermined angle of view is obtained as a whole. In addition, in the embodiment described here, the fish-eye lenses are used. However, as long as a predetermined angle of view is obtained as a whole, other wide-angle lenses or super-wide-angle lenses may be used instead of the fish-eye lens.

The relative positions of the optical elements (lenses, prisms, filters, and aperture stops) of the two lens optical systems 20A and 20B are determined with respect to the image sensors 22A and 22B (hereinafter, referred to collectively as an image sensor 22). More specifically, these elements are positioned such that the optical axis of the optical elements of each of the lens optical systems 20A and 20B meets the central portion of the light receiving area of corresponding one of the image sensors 22 at the right angle and such that the light receiving area serves as the image-forming plane of corresponding one of the fish-eye lenses. In the embodiment described here, a turning optical system is used in which two right-angle prisms distribute the light beams focused by the two lens optical systems 20A and 20B to the two image sensors 22A and 22B, respectively, so as to reduce disparity between the optical systems. However, no limitation is intended thereby, and a three-turning structure, in which an incident light beam turns three times while traveling within the optical system, may be used to reduce disparity. Alternatively, a straight optical system may be used to reduce cost.

In the embodiment illustrated in FIG. 2, the lens optical systems 20A and 20B have the same specification, and are combined to face the opposite directions such that the optical axes thereof meet each other. The image sensors 22A and 22B each convert the light distribution of the received light into an image signal, and sequentially output images to the image processing block of the control board. Although the details are described later, the images captured by the image sensors 22A and 22B are combined into an image having a solid angle of 4π steradians (hereinafter referred to as a "spherical image"). The spherical image is an image of all the directions that can be seen from an image capturing point. In the embodiment described here, a spherical image is generated. However, in some embodiments, the captured image may be an omnidirectional image obtained by capturing a horizontal plane at 360 degrees, i.e., a 360-degree panoramic image, or may be an image obtained by capturing a portion of an omnidirectional view or a panoramic view at a horizontal plane of 360 degrees (for example, an omnidirectional (dome) image obtained by capturing a horizontal plane at 360 degrees and a vertical plane at 90 degrees from the horizontal plane). The spherical image may be acquired as a still image or a moving image.

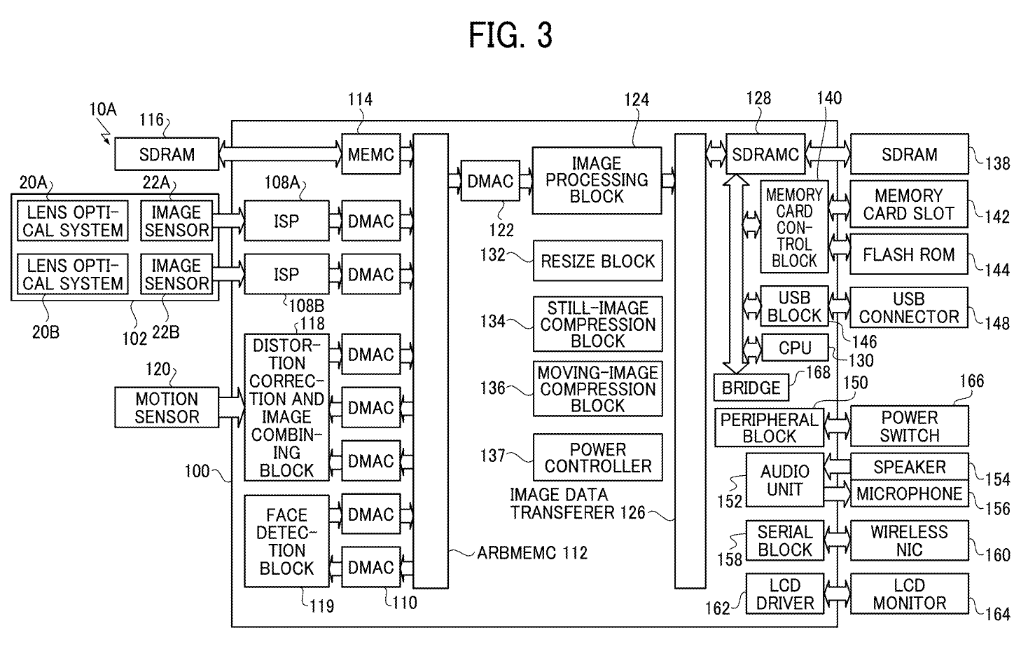

FIG. 3 is a block diagram illustrating hardware of the spherical-image capturing apparatus 10A according to the present embodiment.

The spherical-image capturing apparatus 10A includes a digital still camera processor (hereinafter, referred to simply as a processor) 100, a barrel unit 102, and various components connected to the processor 100. The barrel unit 102 includes the pair of lens optical systems 20A and 20B and the pair of image sensors 22A and 22B as described above. The image sensor 22 is controlled by a control command from a central processing unit (CPU) 130 in the processor 100. Details of the CPU 130 will be described later.

The processor 100 includes image signal processors (ISPs) 108A and 108B, a direct memory access controller (DMAC) 110, and an arbiter or arbitration memory controller (ARBMEMC) 112 that mediates the memory access. The processor 100 further includes a memory controller (MEMC) 114 that controls the memory access, a distortion correction and image combining block 118, and a face detection block 119. The ISPs 108A and 108B each perform automatic exposure (AE) control, auto white balance (AWB) adjustment, and gamma setting on images input through signal processes of the image sensors 22A and 22B, respectively. In FIG. 3, the two ISPs 108A and 108B are provided for the two image sensors 22A and 22B. This configuration is merely one example. In some examples, one ISP may be provided for two image sensors 22A and 22B.

The MEMC 114 is connected to a synchronous dynamic random access memory (SDRAM) 116. The SDRAM 116 temporarily stores data when the ISPs 108A and 108B and the distortion correction and image combining block 118 perform their processes. The distortion correction and image combining block 118 performs distortion correction and zenith correction on two captured images obtained from two sets of the lens optical systems 20 and the image sensors 22 using information from a motion sensor 120, and combines the corrected images. The motion sensor 120 may include a three-axis acceleration sensor, a three-axis angular velocity sensor, and a geomagnetic sensor. The face detection block 119 detects a face from the image and identifies the location of the face of a person. In addition to or instead of the face detection block 119, an object recognition block that recognizes the whole body image of a person, the face of an animal such as a cat or a dog, or another object such as a car or a flower may be provided.

The processor 100 further includes a direct memory access controller (DMAC) 122, an image processing block 124, the CPU 130, an image data transferer 126, a synchronous dynamic random access memory controller (SDRAMC) 128, a memory card control block 140, a universal serial bus (USB) block 146, a peripheral block 150, an audio unit 152, a serial block 158, a liquid crystal display (LCD) driver 162, and a bridge 168.

The CPU 130 controls the operation of each section of the spherical-image capturing apparatus 10A. The image processing block 124 performs various image processing operations on image data. The processor 100 further includes a resize block 132. The resize block 132 increases or reduces the size of the image data by interpolation. The processor 100 further includes a still-image compression block 134. The still-image compression block 134 is a codec block for compressing or expanding a still image so as to change the format of the still image to a still-image format such as Joint Photographic Experts Group (JPEG) or Tagged Image File Format (TIFF). The still-image compression block 134 is used to generate still-image data of the generated spherical image. The processor 100 further includes a moving-image compression block 136. The moving-image compression block 136 is a codec block for compressing or expanding moving images so as to change the format of the moving images to a video format such as Moving Picture Experts Group (MPEG)-4 Advanced Video Coding (AVC)/H.264. The moving-image compression block 136 is used to generate moving-image data of the generated spherical image. The processor 100 further includes a power controller 137.

The image data transferer 126 transfers the image that has been processed by the image processing block 124. The SDRAMC 128 controls an SDRAM 138 connected to the processor 100, and the SDRAM 138 stores the image data on a temporary basis while various kinds of image processing are being performed on the image data inside the processor 100. The memory card control block 140 controls reading and writing from and to a flash read-only memory (ROM) 144 and a memory card that is inserted into a memory card slot 142. The memory card slot 142 is a slot through which a memory card is detachably inserted into the spherical-image capturing apparatus 10A. The USB block 146 controls USB communication with an external device such as a personal computer connected via a USB connector 148. A power switch 166 is connected to the peripheral block 150.

The audio unit 152 is connected to a microphone 156 to which an audio signal is input by a user, and a speaker 154 from which the recorded audio signal is output, and controls the input and output of the audio data. The serial block 158 controls serial communication with an external device such as a personal computer and is connected to a wireless network interface card (NIC) 160. The LCD driver 162 is a drive circuit that drives an LCD monitor 164, and converts the image signals into signals such that the LCD monitor 164 can display thereon various kinds of conditions. In addition to the components in FIG. 3, a video interface such as High-Definition Multimedia Interface (HDMI^{®}) may be provided.

The flash ROM 144 stores therein a control program described in a code readable by the CPU 130 and various kinds of parameters. When the power is turned on by the operation of the power switch 166, the control program stored in the ROM 144 is loaded into a main memory operating as a work area for the CPU 130. The CPU 130 executes the program read into the main memory to control the operations of the sections of the apparatus. At the same time, data for controlling the operations is temporarily stored in the SDRAM 138 and a local static random access memory (SRAM). Note that the rewritable flash ROM 144 allows changes in the control program and the parameters for control and thus facilitates upgrade of the version of the functions.

The hardware configuration included in the spherical-image capturing apparatus 10A has been described above. When an image is captured by the imaging apparatus 10 such as the spherical-image capturing apparatus 10A, metadata can be added to the data of the image. The metadata can include, for example, capturing conditions such as a capturing date and time, an International Organization for Standardization (ISO) sensitivity, a shutter speed, and an aperture value. In the embodiment described here, metadata including additional information can be further added, for example, to facilitate search and management of images. For example, when a real estate agent captures an image of a property and provides information, metadata such as the name and location of the property is added to the data of the image, thereby increasing the searchability. In contrast, when metadata other than the capturing condition is added, it is desirable to set which metadata is to be added, which takes time and effort for the person who captures the image. Setting of metadata includes, for example, various methods such as reading of a code, selection from a list, setting via the network, and direct input by an operation performed by the user. Which method is preferable for setting metadata varies depending on the user, and it is desirable to increase the selectivity of setting. With the present embodiment, metadata to be added can be easily set with the configuration described below.

While the embodiment described here illustrates the case where the real estate agent captures an image of a property and adds information relating to the property as metadata, no limitation is intended thereby. Thus, the embodiment can be applied to other examples. For example, an image of a used car may be captured and information relating to the car may be added as metadata, or an image of the inside of a store may be captured and information relating to a sales floor may be added as metadata.

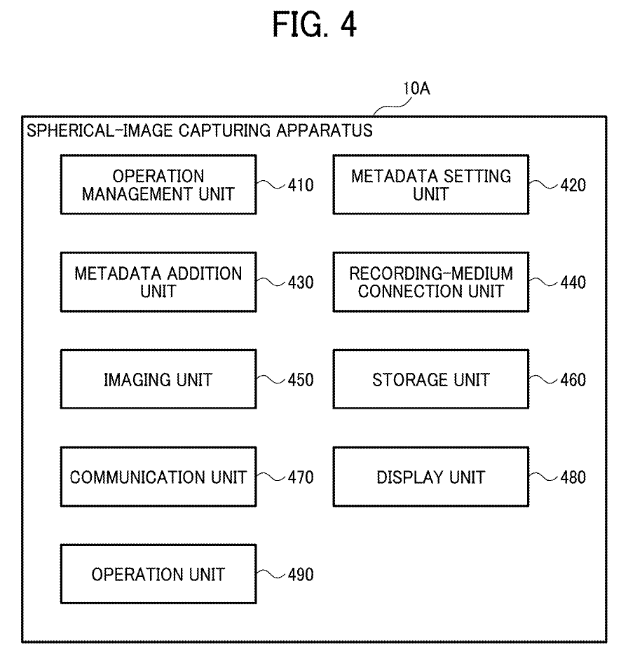

Functional units executed by the hardware according to the present embodiment will be described below with reference to FIG. 4. FIG. 4 is a block diagram illustrating software included in the spherical-image capturing apparatus 10A. The spherical-image capturing apparatus 10A includes functional units of an operation management unit 410, a metadata setting unit 420, a metadata addition unit 430, a recording-medium connection unit 440, an imaging unit 450, a storage unit 460, a communication unit 470, a display unit 480, and an operation unit 490. Details of each functional unit will be described below.

The operation management unit 410 manages settings relating to the operation of the spherical-image capturing apparatus 10A. The operation management unit 410 corresponds to management means. The operation management unit 410 can manage settings by various methods such as setting an operation from a setting file recorded in a memory card, setting an operation from the server apparatus 50 via the network, and setting an operation by an operation performed by the user.

The metadata setting unit 420 sets metadata to be added to a captured image. The metadata setting unit 420 corresponds to setting means. The metadata setting unit 420 can set the metadata to be added by various methods such as a method of reading a bar code or a two-dimensional code indicating metadata to set the metadata, a method of selecting metadata to be added from a list, a method of setting metadata via the network, and a method of allowing the user to directly input metadata. The metadata setting method can be set and managed by the operation management unit 410.

The metadata addition unit 430 adds metadata to data of an image. The metadata addition unit 430 corresponds to addition means. The metadata addition unit 430 can add the metadata set by the metadata setting unit 420 to the data of the captured image. For example, the data of the image to which the metadata is added may be transmitted to the server apparatus 50 via the network and stored in the server apparatus 50, or may be stored in a recording medium via the recording-medium connection unit 440.

The recording-medium connection unit 440 is connected to a recording medium. The recording-medium connection unit 440 corresponds to connection means and can serve as reading means or writing means. The recording-medium connection unit 440 can read data from the recording medium and write data to the recording medium. The recording-medium connection unit 440 can be connected to various recording media such as a secure digital (SD) card inserted into the memory card slot 142 and a USB memory inserted into the USB connector 148. The recording-medium connection unit 440 can read a setting file stored in a connected recording medium and write captured image data.

The imaging unit 450 controls the operation of the image sensor 22 to capture an image. The imaging unit 450 corresponds to imaging means. The imaging unit 450 can capture an image such as a still image or a moving image. The imaging unit 450 can capture an image of a code (for example, a bar code or a two-dimensional code) including various kinds of information and read the information.

The communication unit 470 performs communication between the spherical-image capturing apparatus 10A and another device or apparatus. The communication unit 470 corresponds to communication means and is implemented by, for example, the radio NIC 160. For example, the communication unit 470 can communicate with the server apparatus 50 via the network to transmit data of a captured image. The communication unit 470 can receive an operation setting set by the server apparatus 50.

The display unit 480 displays various kinds of information relating to the spherical-image capturing apparatus 10A. The display unit 480 corresponds to display means. The display unit 480 can display, for example, a screen for setting metadata. Examples of the display unit 480 include a liquid crystal display and an organic electroluminescent (EL) display; however, this configuration is merely one example, and the display unit 480 may be, for example, a light-emitting diode (LED).

The operation unit 490 performs an operation on the spherical-image capturing apparatus 10A. The operation unit 490 corresponds to operation means. The operation unit 490 may be, for example, a physical button such as the shutter button 18 or a numeric keypad. When the display unit 480 is implemented by a touch panel display, the operation unit 490 may be implemented in a form like a virtual keyboard. The operation unit 490 can perform, for example, an operation of capturing an image, an operation of setting a capturing condition, an operation of adding metadata, and an operation of selecting metadata.

The above-described software blocks correspond to functional units that are implemented by causing hardware to function when the CPU 130 executes the program according to the present embodiment. In any one of the above-described embodiments, all of the above-described functional units may be implemented by software, hardware, or a combination of software and hardware.

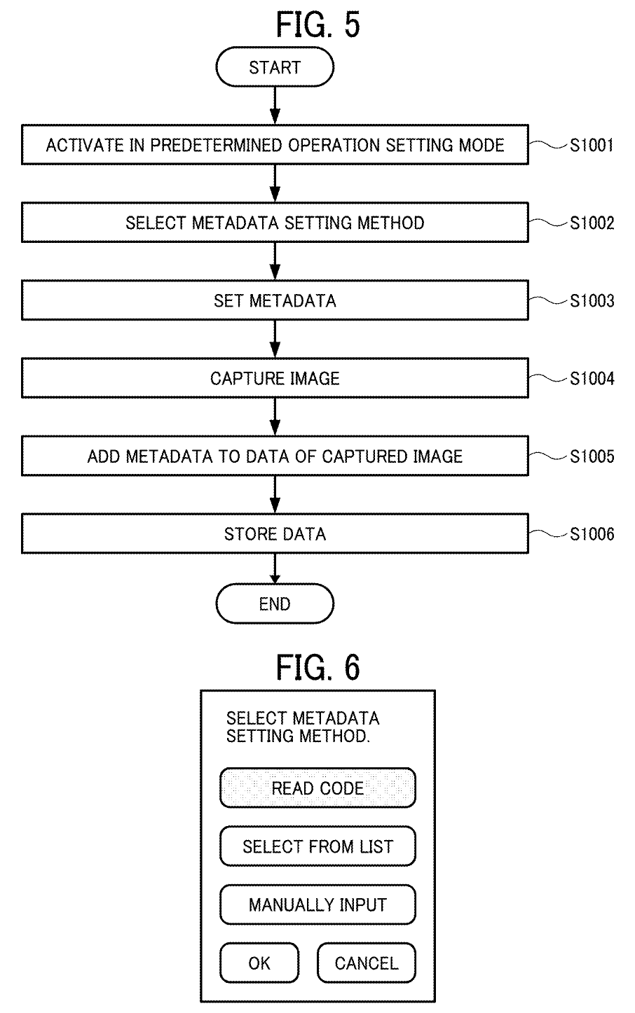

Next, processes executed by the above-described functional units will be described. FIG. 5 is a flowchart of processes executed by the spherical-image capturing apparatus 10A. The flowchart in FIG. 5 presents an example of a series of processes performed by the spherical-image capturing apparatus 10A from activation to capturing of an image.

In step S1001, the spherical-image capturing apparatus 10A is activated in a predetermined operation setting mode. In step S1001, the spherical-image capturing apparatus 10A can be activated in, for example, a mode set by the operation management unit 410. The spherical-image capturing apparatus 10A can be activated in, for example, a mode in which a setting file is read from a memory card, a mode set via the network, or a mode set by the user.

After activation of the spherical-image capturing apparatus 10A, in step S1002, the user selects a metadata setting method. Examples of the metadata setting method include a method of reading a bar code or a two-dimensional code indicating metadata to set metadata, a method of selecting metadata to be added from a list, a method of setting metadata via the network, and a method of allowing the user to directly input metadata. However, no limitation is intended thereby. The metadata setting method selected in step S1002 may be defined by, for example, a setting file of a memory card, a setting file set from the network, or a setting file stored in the storage unit 460 of the spherical-image capturing apparatus 10A.

An example of a screen displayed in the process in step S1002 will be described with reference to FIG. 6. FIG. 6 is a view illustrating an example of a screen for selecting a metadata setting method displayed on the spherical-image capturing apparatus 10A.

As illustrated in FIG. 6, a screen for selecting a metadata setting method is displayed on the spherical-image capturing apparatus 10A in the process in step S1002. In the example in FIG. 6, for example, various setting methods such as "read code," "select from list," and "manually input" are displayed, and an "OK" button and a "cancel" button are displayed together. The user can select an appropriate setting method from the screen as illustrated in FIG. 6.

The description returns to FIG. 5. After the metadata setting method is selected in step S1002, the process proceeds to step S1003. In step S1003, the metadata setting unit 420 sets metadata to be added to the data of a captured image.

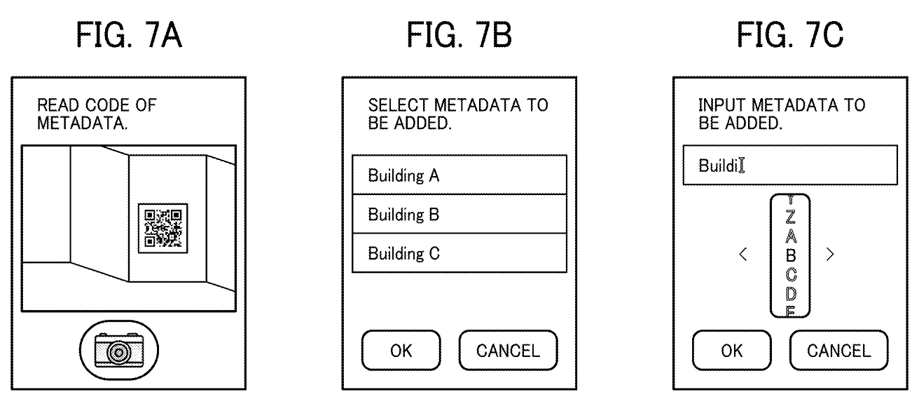

An example of a screen displayed in the process in step S1003 will be described with reference to FIGS. 7A to 7C. FIGS. 7A to 7C are views illustrating examples of a screen for setting metadata displayed on the spherical-image capturing apparatus 10A. FIG. 7A illustrates an example of a screen for reading a bar code or a two-dimensional code indicating metadata to set the metadata. FIG. 7B illustrates an example of a screen for selecting metadata to be added from a list. FIG. 7C illustrates an example of a screen on which the user inputs metadata.

First, FIG. 7A will be described. On the screen illustrated in FIG. 7A, for example, an area in which an image acquired by the image sensor 22 and a button for performing a reading operation are displayed together with a message "Read code of metadata." When the user performs an operation via the screen illustrated in FIG. 7A, the user can set information indicated by the read code as metadata to be added.

The code may be a bar code, a two-dimensional code, or the like, and may be provided, for example, on an imaging object or in a space in which an imaging object is placed. The code according to the present embodiment may be, for example, a code indicating information on a real estate property, and may be provided in advance in the property or the like. With the embodiment described here, when the real estate agent captures an image of the inside of a room of a property, the real estate agent reads a code of metadata to add metadata of information (for example, the name and location of the property) indicated by the code to the data of the captured image. Accordingly, management and search of the captured image can be easily performed.

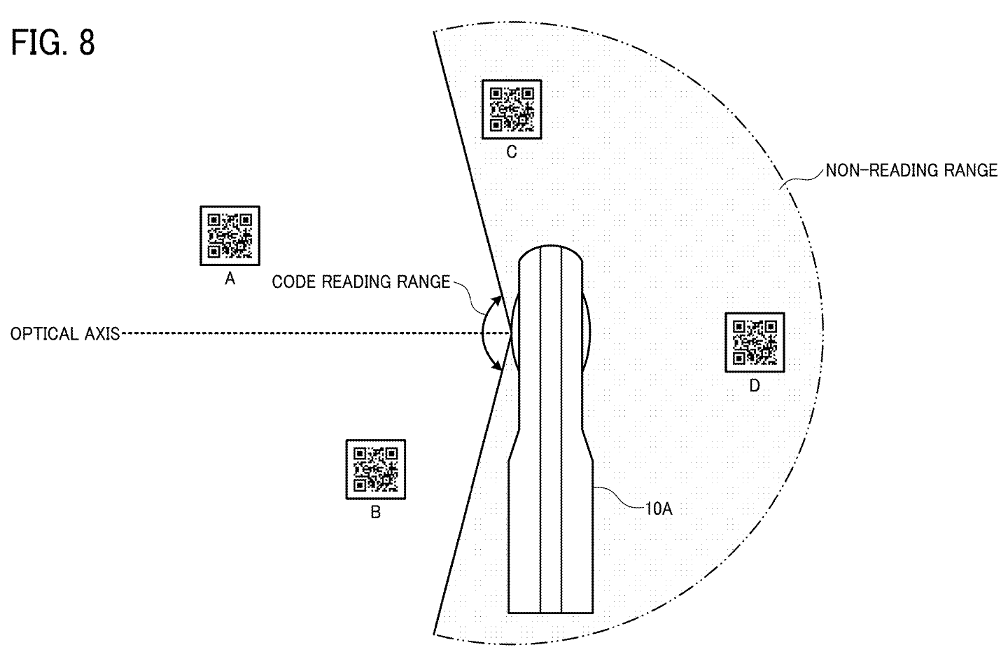

When an imaging apparatus including multiple fish-eye lenses, such as the spherical-image capturing apparatus 10A, is used, a code included in a predetermined area may be read. Reading of a code according to the present embodiment will be described with reference to FIG. 8. FIG. 8 is a diagram illustrating an example in which the spherical-image capturing apparatus 10A reads a code according to the present embodiment.

As illustrated in FIG. 8, in the spherical-image capturing apparatus 10A, a predetermined range from the optical axis of one lens can be used as a code reading range. In the case of a spherical-image capturing apparatus 10A including multiple lenses, multiple images captured by the multiple lenses are joined together by image processing, and hence the image quality is likely to decrease in an area where images overlap each other. Due to this, in an area where the imaging range of one lens overlaps the imaging range of another lens, the accuracy of reading the code may decrease. Thus, as illustrated in FIG. 8, a predetermined range from the optical axis may be used as a code reading range, and a code within the code reading range may be a reading object. For example, in the example in FIG. 8, codes located at positions A and B in the code reading range are used as reading objects, whereas codes located at positions C and D in a non-reading range (an area indicated with a dark color in FIG. 8) are not used as reading objects. Accordingly, the accuracy of reading the code can be increased.

When the metadata is set by reading the code, multiple frames may be continuously captured to read the code. For example, the metadata setting unit 420 may continuously capture multiple images including a code, and when codes read from a predetermined number of images include the same information, the metadata setting unit 420 may set metadata of the code. In this way, by confirming that the same code is read in multiple frames, the reading accuracy of the code can be increased.

Next, FIG. 7B will be described. On the screen illustrated in FIG. 7B, for example, a list of metadata is displayed together with a message "Select metadata to be added." In the example of the screen in FIG. 7B, for example, a list including items "BuildingA," "BuildingB," and "BuildingC" indicating the names of properties is displayed. For example, when the real estate agent is the user, the user can select the name of a property to be captured, that is, metadata to be added, from the displayed list. Accordingly, desired metadata can be added to the captured image.

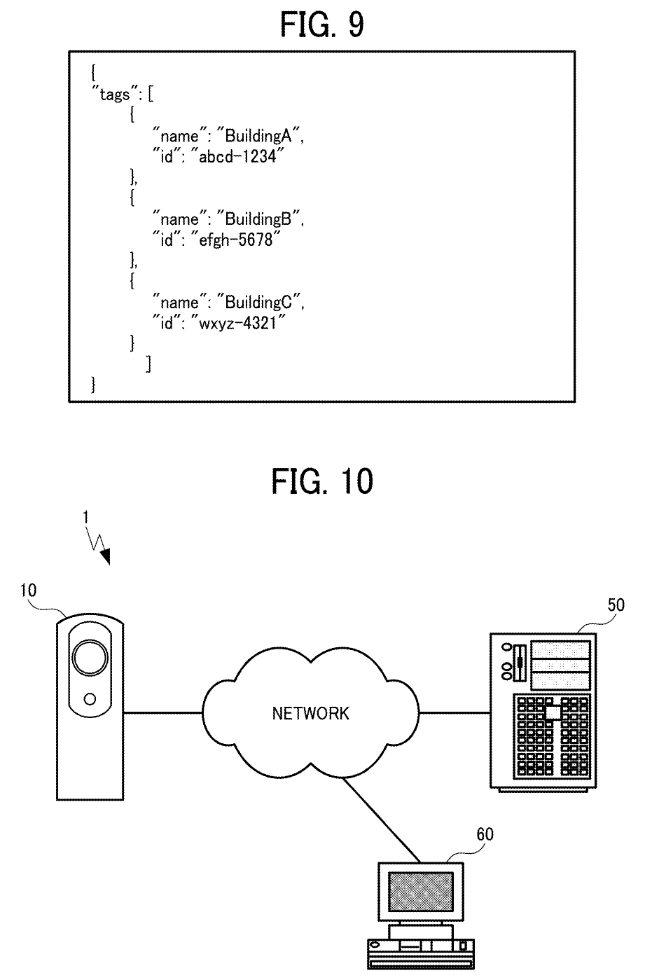

The items of metadata displayed in the list can be defined by, for example, a setting file in a JavaScript Object Notation (JSON) format. For example, when a setting file stored in a memory card is read or a setting file is read from the server apparatus 50 via the network, the list as illustrated in FIG. 7B can be displayed. The setting file according to the present embodiment will be described with reference to FIG. 9. FIG. 9 is a view illustrating an example of a setting file of a list of metadata according to the present embodiment.

As illustrated in FIG. 9, in the setting file, a name (name) to be displayed in the list and a code (id) indicating metadata are defined in association with each other. With the example in FIG. 9, metadata of items whose names are "BuildingA," "BuildingB," and "BuildingC" is defined. Further, metadata with an id "abcd-1234" is associated with "BuildingA." Thus, when the user selects "BuildingA" on the screen illustrated in FIG. 7B, the metadata of "abcd-1234" can be added to the captured image.

The name and metadata displayed in the list are not necessarily the same, and the name and id defined in the setting file may differ from each other. That is, as illustrated in FIG. 9, the name different from the content of the metadata to be added, such as the name "BuildingA" and the id "abcd-1234," may be defined to be displayed in the list. As described above, by defining the display name different from the content of the metadata to be added, the user can easily recognize which metadata is to be selected, and the convenience of the user can be increased.

Next, FIG. 7C will be described. On the screen illustrated in FIG. 7C, a user interface (UI) for inputting a character string is displayed together with a message "Input metadata to be added." When the user inputs metadata to be added from the screen illustrated in FIG. 7C, the user can add any metadata to a captured image. An example of a configuration in which characters are input through a screen operation is illustrated in the example in FIG. 7C; however, no limitation is intended thereby. Thus, for example, a character string may be input by an operation of a physical button.

The setting of the metadata is not limited to the setting by the operation performed by the user as illustrated in FIG. 7C, and the metadata may be set by another method. For example, the metadata may be set in advance via the network, and hence time and effort for the user to set the metadata can be reduced.

The description returns to FIG. 5. After the metadata is set in step S1003, the process proceeds to step S1004. In step S1004, the imaging unit 450 captures an image. For example, in the embodiment described here, the real estate agent may capture a spherical image of the inside of a room of a property. When the same metadata is added, multiple images may be captured in step S1004.

In step S1005, the metadata set in step S1003 is added to the image captured in step S1004. Accordingly, the searchability of the captured image can be increased, and the convenience of managing the image can be increased.

In step S1006, the data of the image to which the metadata is added is stored. For example, the data may be stored in an internal storage area of the spherical-image capturing apparatus 10A or may be stored in a recording medium such as a memory card via the recording-medium connection unit 440. The data may be transmitted to the server apparatus 50 via the communication unit 470 and stored in a storage area of the server apparatus 50. After the data is stored, the process is ended.

With the processes presented in FIG. 5, the spherical-image capturing apparatus 10A can select the metadata setting method, and hence the convenience of the user can be increased. Since the metadata can be set by the method suitable for the user and the metadata can be added to the data of the image, the manageability and searchability of the captured image can be increased.

An example of adding metadata has been described above. Another example relating to setting of metadata via the network will be described in more detail below.

FIG. 10 is a schematic diagram illustrating a configuration of an information processing system 1 in another example. As illustrated in FIG. 10, in another example, the information processing system 1 may include a personal computer terminal 60 in addition to the configuration illustrated in FIG. 1. The imaging apparatus 10 and the server apparatus 50 illustrated in FIG. 10 are similar to those described with reference to FIG. 1, and hence the detailed description thereof will be omitted.

The personal computer terminal 60 is an information processing terminal that accesses the server apparatus 50 and executes an application relating to the imaging apparatus 10. The personal computer terminal 60 can be used by, for example, an administrator of the camera, and can perform a process such as registration of metadata. The personal computer terminal 60 illustrated in FIG. 10 is an example of an information processing terminal, and no limitation is intended thereby. Thus, the information processing terminal may be a terminal other than the personal computer terminal 60, and may be, for example, a smartphone terminal or a tablet terminal.

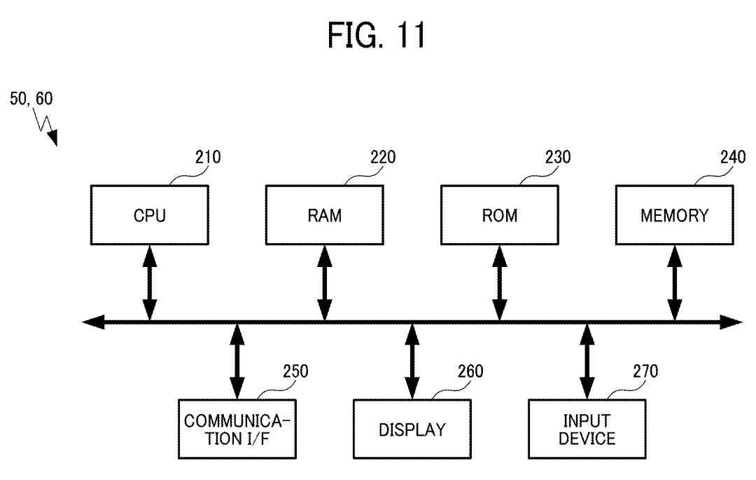

FIG. 11 is a diagram illustrating a hardware configuration included in each of the server apparatus 50 and the personal computer terminal 60 in another example. The server apparatus 50 and the personal computer terminal 60 each include a CPU 210, a random access memory (RAM) 220, a ROM 230, a memory 240, a communication interface (I/F) 250, a display 260, and an input device 270, and the hardware components are connected to one another via a bus. The server apparatus 50 does not necessarily include the display 260 and the input device 270.

The CPU 210 is a device that executes a program for controlling the operation of the server apparatus 50 or the personal computer terminal 60 and performs a predetermined process. The RAM 220 is a volatile memory functioning as an area for deploying a program executed by the CPU 210, and is used for storing or expanding programs and data. The ROM 230 is a non-volatile memory for storing such as programs and firmware to be executed by the CPU 210.

The memory 240 is a readable and writable non-volatile memory that stores the operating system (OS) for operating the server apparatus 50 or the personal computer terminal 60, various software, setting information, and various data. Examples of the memory 240 include a hard disk drive (HDD) and a solid state drive (SSD).

The communication I/F 250 connects the server apparatus 50 or the personal computer terminal 60 to the network and enables communication with another device or apparatus via the network. Communication via the network may be either wired communication or wireless communication, and various data can be transmitted and received using a predetermined communication protocol such as Transmission Control Protocol/Internet Protocol (TCP/IP).

The display 260, which may be implemented by an LCD, displays various data, an operating state of the server apparatus 50 or the personal computer terminal 60, etc. to the user. The input device 270, which may be implemented by a keyboard or a mouse, allows the user to operate the server apparatus 50 or the personal computer terminal 60. The display 260 and the input device 270 may be separate devices, or may be integrated into one device as in the case of a touch panel display.

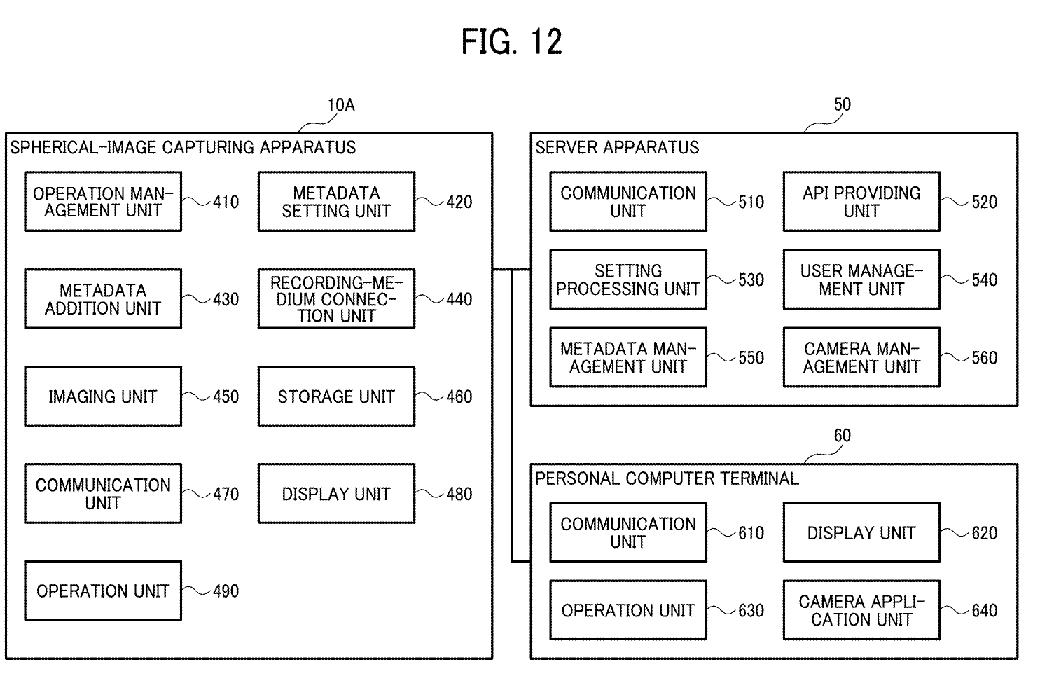

FIG. 12 is a block diagram of software included in the information processing system 1 in another example. As illustrated in FIG. 12, a spherical-image capturing apparatus 10A includes functional units of an operation management unit 410, a metadata setting unit 420, a metadata addition unit 430, a recording-medium connection unit 440, an imaging unit 450, a storage unit 460, a communication unit 470, a display unit 480, and an operation unit 490. The server apparatus 50 includes functional units of a communication unit 510, an application programming interface (API) providing unit 520, a setting processing unit 530, a user management unit 540, a metadata management unit 550, and a camera management unit 560. The personal computer terminal 60 includes functional units of a communication unit 610, a display unit 620, an operation unit 630, and a camera application unit 640. Details of each functional unit will be described below. The functional units of the spherical-image capturing apparatus 10A are similar to those described with reference to FIG. 4, and the detailed description thereof will be omitted.

The functional units of the server apparatus 50 will be described. The communication unit 510 of the server apparatus 50 is similar to the communication unit 470 of the spherical-image capturing apparatus 10A, and the detailed description thereof will be omitted.

The API providing unit 520 provides an API relating to a service according to the present embodiment. The API providing unit 520 corresponds to providing means. The API providing unit 520 can provide, for example, an application relating to setting of the spherical-image capturing apparatus 10A to the personal computer terminal 60 via the network.

The setting processing unit 530 performs a process relating to various settings of a service according to the present embodiment. The setting processing unit 530 corresponds to setting means. The setting processing unit 530 can perform, for example, setting of a user who uses the spherical-image capturing apparatus 10A, setting of metadata of the spherical-image capturing apparatus 10A, and setting of the spherical-image capturing apparatus 10A.

The user management unit 540 manages a user who uses the spherical-image capturing apparatus 10A. The user management unit 540 corresponds to management means. The user management unit 540 can manage the user based on the setting process performed by the setting processing unit 530. Information to be managed by the user management unit 540 will be described later.

The metadata management unit 550 manages metadata of the spherical-image capturing apparatus 10A. The metadata management unit 550 corresponds to management means. The metadata management unit 550 can manage metadata based on the setting process performed by the setting processing unit 530. Information to be managed by the metadata management unit 550 will be described later.

The camera management unit 560 manages the spherical-image capturing apparatus 10A. The camera management unit 560 corresponds to management means. The camera management unit 560 can manage the camera based on the setting process performed by the setting processing unit 530. Information to be managed by the camera management unit 560 will be described later.

The functional units of the personal computer terminal 60 will be described. The communication unit 610, the display unit 620, and the operation unit 630 of the personal computer terminal 60 are similar to the communication unit 470, the display unit 480, and the operation unit 490 of the spherical-image capturing apparatus 10A, respectively, and the detailed description thereof will be omitted.

The camera application unit 640 executes an application relating to a service according to the present embodiment. The camera application unit 640 corresponds to application execution means. The camera application unit 640 can execute, for example, an application provided by the API providing unit 520. For example, the application executed by the camera application unit 640 may be installed in the personal computer terminal 60 or may be executed on a web browser.

The above-described software blocks correspond to functional units that are implemented by causing hardware to function when the CPU 130 or 210 executes the program according to the present embodiment. In any one of the above-described embodiments, all of the above-described functional units may be implemented by software, hardware, or a combination of software and hardware.

Furthermore, all of the above-described functional units may not be necessarily included in each apparatus with the configuration illustrated in FIG. 12. For example, in another preferred embodiment, each functional unit may be implemented by cooperation of two or more apparatuses among the spherical-image capturing apparatus 10A, the server apparatus 50, and the personal computer terminal 60.

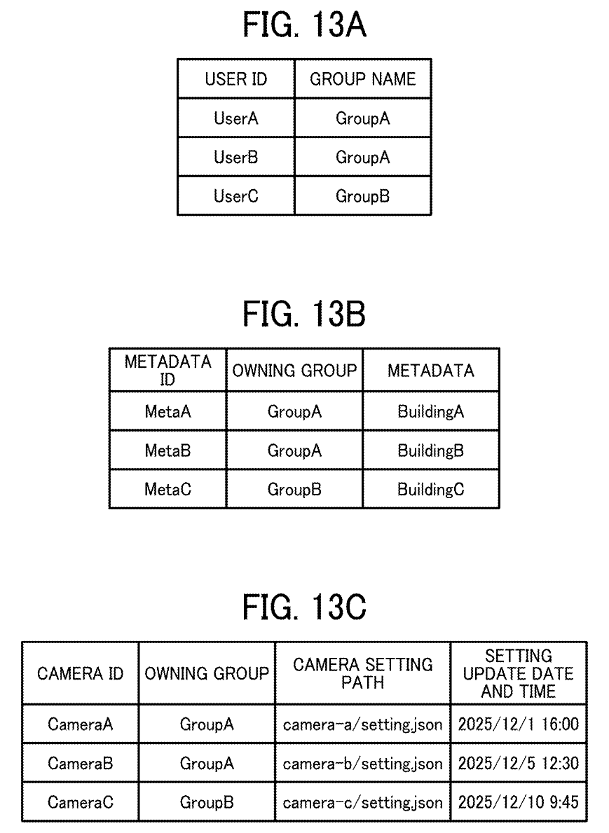

Data managed by the user management unit 540, the metadata management unit 550, and the camera management unit 560 will be described with reference to FIGS. 13A to 13C. FIGS. 13A to 13C are diagrams illustrating an example of various tables to be managed in another example. FIG. 13A illustrates an example of a user management table managed by the user management unit 540. FIG. 13B illustrates an example of a metadata management table managed by the metadata management unit 550. FIG. 13C illustrates an example of a camera management table managed by the camera management unit 560.

The user management table in FIG. 13A will be described. As illustrated in FIG. 13A, a user identification (ID) and a group name are stored in association with each other in the user management table. The user ID is a unique ID for identifying a user. The group name is a name of a group to which the user belongs. By assigning users to groups, when multiple users share a camera, the camera can be managed for each group, and the manageability can be increased. With the management of users as illustrated in FIG. 13A, for example, when a user logs in to the camera application, access can be limited to information relating to the group to which the user belongs, and security can be increased. The user management table may include information other than the items illustrated in FIG. 13A.

The metadata management table in FIG. 13B will be described. As illustrated in FIG. 13B, a metadata ID, an owning group, and metadata are stored in association with one another in the metadata management table. The metadata ID is a unique ID for identifying metadata. The owning group indicates a group that can access the metadata.

Thus, in the example in FIG. 13B, just the user belonging to GroupA can access the metadata of MetaA. The metadata is information on metadata to be added to the captured image. In the example in FIG. 13B, BuildingA, BuildingB, and BuildingC are set as metadata. The metadata name may be any information and may be, for example, the name or location (address) of a property; however, no limitation is intended thereby. The metadata management table may include information other than the items illustrated in FIG. 13B.

The camera management table in FIG. 13C will be described. As illustrated in FIG. 13C, a camera ID, an owning group, a camera setting path, and a setting update date and time are stored in association with one another in the camera management table. The camera ID is a unique ID for identifying a camera (for example, the spherical-image capturing apparatus 10A). The owning group indicates a group of users who own the camera, and for example, just the user of the corresponding group can change the setting of the camera. The camera setting path indicates an address at which the setting file of the camera is stored. By accessing the address indicated by the path, the camera can download the setting file, and hence, for example, a list of metadata can be acquired. The setting update date and time indicate the date and time when the setting file at the access destination of the camera setting path has been updated. The camera management table may include information other than the items illustrated in FIG. 13C (e.g., information indicating the version of the firmware of the camera).

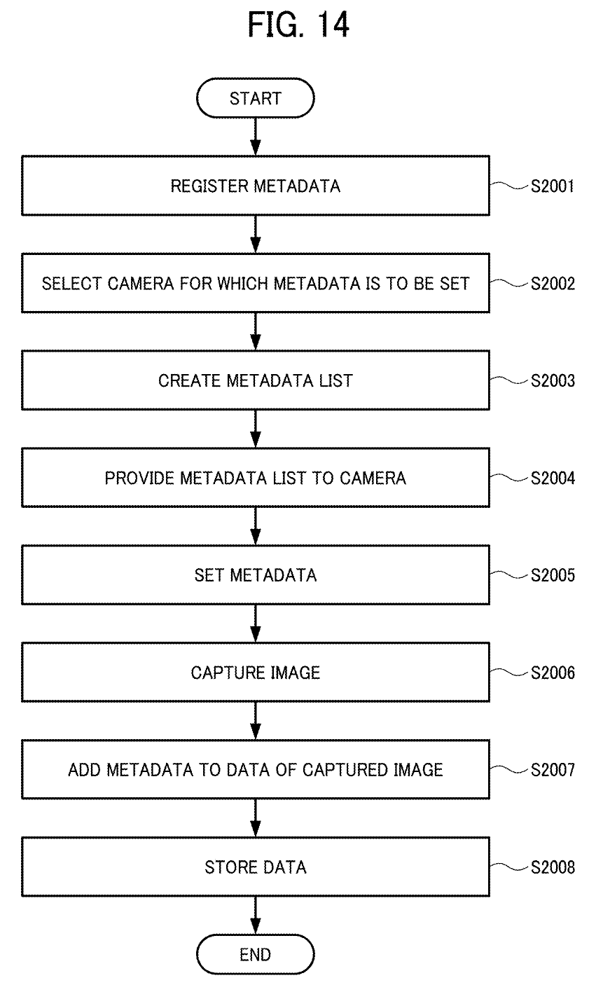

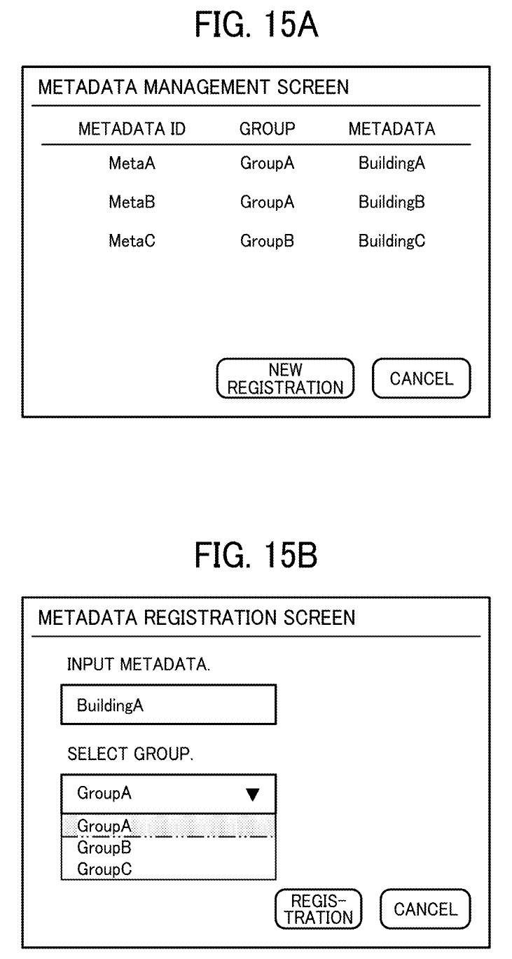

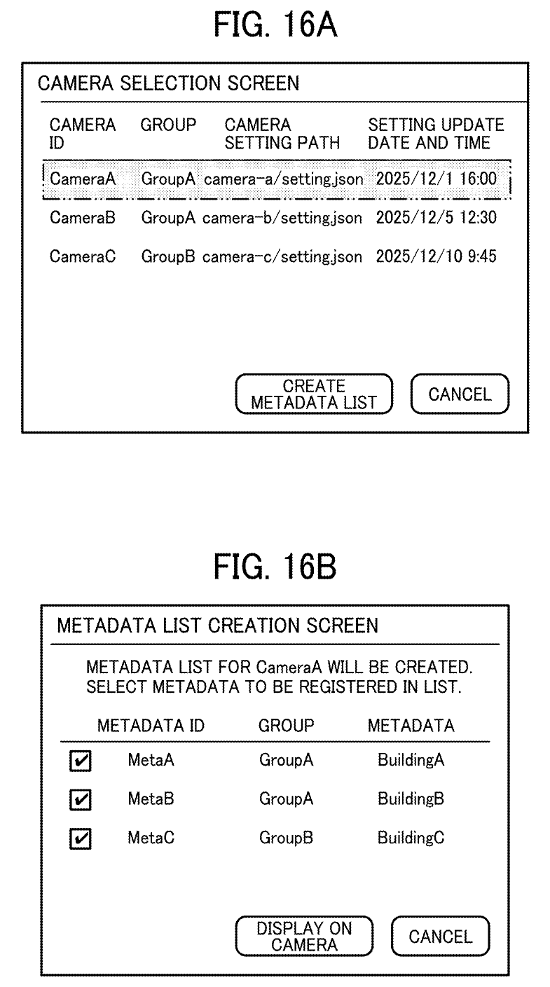

Processes in another example will be described with reference to FIG. 14. FIG. 14 is a flowchart of processes of setting metadata in another example. In the following description with reference to FIG. 14, description will be given with reference to FIGS. 15A, 15B, 16A, and 16B as appropriate. FIGS. 15A to 16B are diagrams illustrating examples of screens relating to setting of metadata displayed on the personal computer terminal 60 in another example.

In step S2001, metadata to be provided to the spherical-image capturing apparatus 10A is registered via the network. The registration of the metadata in step S2001 can be performed using the personal computer terminal 60. For example, the metadata can be registered in cooperation of the API providing unit 520, the setting processing unit 530, and the camera application unit 640. The API providing unit 520 can provide a screen relating to setting of metadata via the camera application unit 640. The screen relating to the setting of metadata may be, for example, screens as illustrated in FIGS. 15A and 15B.

FIG. 15A illustrates an example of a metadata management screen. For example, information corresponding to the metadata management table in FIG. 13B can be displayed. When a "new registration" button is pressed on the screen illustrated in FIG. 15A, the screen transitions to a metadata registration screen as illustrated in FIG. 15B.

On the metadata registration screen illustrated in FIG. 15B, a field for inputting metadata and a pull-down list for selecting a group are displayed. The administrator of the camera inputs metadata on the screen illustrated in FIG. 15B, selects a group, and then presses a "registration" button. Accordingly, new metadata can be registered in the metadata management table illustrated in FIG. 13B.

The description returns to FIG. 14. After the metadata is registered in step S2001, in step S2002, a camera for which metadata is to be set is selected. In step S2003, a metadata list is created. In step S2004, the metadata list is provided to the camera (the camera downloads the metadata list). The processes in steps S2002 to S2004 can be performed in cooperation of, for example, the API providing unit 520, the setting processing unit 530, and the camera application unit 640, as in step S2001. The screens displayed in steps S2002 to S2004 may be, for example, screens illustrated in FIGS. 16A and 16B.

FIG. 16A illustrates a camera selection screen displayed in step S2002. For example, information corresponding to the camera management table in FIG. 13C can be displayed. When a camera for which metadata is to be set is selected on the screen illustrated in FIG. 16A (FIG. 16A illustrates an example of a state in which CameraA is selected) and a "create metadata list" button is pressed, the screen transitions to a metadata list creation screen as illustrated in FIG. 16B.

On the metadata list creation screen illustrated in FIG. 16B displayed in step S2003, for example, information corresponding to the metadata management table in FIG. 13B can be displayed together with check boxes. On the screen illustrated in FIG. 16B, the administrator selects metadata to be registered in the metadata list by checking the check box and presses a "display on camera" button. In step S2004, the selected metadata is transmitted as a list to the spherical-image capturing apparatus 10A. As a result, the spherical-image capturing apparatus 10A displays, for example, the list for selecting metadata to be added as illustrated in FIG. 7B.

The description returns to FIG. 14. After the metadata list is provided to the camera in step S2004, the processes in steps S2005 to S2008 are performed. The processes in steps S2005 to S2008 are similar to the processes in steps S1003 to S1006 in FIG. 5, and the detailed description thereof will be omitted. Then, the process is ended.

With the processes illustrated in FIG. 14, in another example, the metadata can be set via the network, and the convenience of the user is increased.

With the embodiments of the present disclosure described above, an imaging apparatus, an information processing system, and a method that can perform setting relating to addition of metadata are provided.

Each of the functions in the above-described embodiments can be implemented by a device executable program written in any one of C, C++, C#, Java^{®}, and the like. The program in the present embodiment can be stored and distributed in any one of device-readable non-transitory storage media that include a hard disk drive, a compact disc read-only memory (CD-ROM), a magneto-optical drive (MO), a digital versatile disc (DVD), a flexible disk, an Electrically Erasable Programmable Read-only Memory (EEPROM^{®}), an Erasable Programmable Read-only Memory (EPROM), and the like. In addition, the program in the present embodiment can be transmitted in a format, which allows another device to use, via a network.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An imaging apparatus comprising:
an imaging device to capture an image; and
circuitry configured to:
set metadata to be added based on a selected metadata setting method; and
add the set metadata to the captured image.

2. The imaging apparatus according to claim 1, wherein the metadata setting method includes at least one of:
a method of setting metadata based on a code read by the imaging device;
a method of setting metadata selected from a list;
a method of setting metadata input by a user; or
a method of setting metadata via a network.

3. The imaging apparatus according to claim 2, wherein the circuitry is configured to read a defined setting file to select the metadata setting method.

4. The imaging apparatus according to claim 1, further comprising a communication circuit to transmit data of the image to which the metadata is added to a server apparatus.

5. The imaging apparatus according to claim 1, wherein the imaging device captures a spherical image.

6. The imaging apparatus according to claim 5, wherein the circuitry is configured to set the metadata based on a code read from an image obtained by the imaging device capturing an area within a predetermined range from an optical axis of a lens included in the imaging device.

7. The imaging apparatus according to claim 2, wherein, in the method of setting the metadata selected from the list, the list is defined by a name that is displayed in the list and a setting file associated with the metadata to be added, and the name differs from the metadata.

8. The imaging apparatus according to claim 2, wherein, when the metadata setting method is the method of setting the metadata via the network, the circuitry is configured to download a metadata list from an information processing apparatus.

9. An information processing system comprising:
an imaging apparatus including an imaging device to capture an image; and
an information processing apparatus including circuitry, the circuitry being configured to:
set metadata to be added based on a selected metadata setting method; and
add the set metadata to the captured image.

10. The information processing system according to claim 9, wherein the imaging device captures a spherical image.

11. The information processing system according to claim 9, wherein the circuitry of the information processing apparatus is configured to:
set a list of the metadata; and
add the metadata from the list of the metadata downloaded from the information processing apparatus.

12. The information processing system according to claim 11, further comprising an information processing terminal,
wherein an application for performing a process of setting the list is installed in the information processing terminal.

13. The information processing system according to claim 12, wherein the information processing apparatus is a server that provides a service to the information processing terminal.

14. A method comprising:
selecting a metadata setting method;
setting metadata to be added by the selected metadata setting method;
capturing an image; and
adding the set metadata to the captured image.

15. The method according to claim 14, further comprising downloading a metadata list from an information processing apparatus,
wherein the adding includes adding metadata selected from the metadata list.
